(19) United States
(12) Patent Application Publication
(10) Pub. No.: US 2013/0089478 A1
(43) Pub. Date: Apr. 11, 2013

(54) PROCESS TO OBTAIN POTASSIUM SULFATE FROM VINASSE

(71) Applicant: Crealabs S.R.L., Buenos Aires (AR)

(72) Inventor: MANUEL RAÚL MORAL, Province of Buenos Aires (AR)

(73) Assignee: Crealab S.R.L., Buenos Aires (AR)

(21) Appl. No.: 13/644,698

(22) Filed: Oct. 4, 2012

(30) Foreign Application Priority Data
Oct. 5, 2011 (AR) P20110103703

(51) Int. Cl. C01D 5/04

(52) U.S. Cl. 423/111; 423/201; 423/173; 423/138

(57) ABSTRACT

A process designed to obtain potassium sulfate from vinasse where such vinasse is mainly obtained as a by-product of ethyl alcohol and the like production distilleries. Such process consists in concentrating vinasse dry solids for their subsequent combustion in a recovery boiler and to obtain electric power by activating a vapor turbine and at the same time recover the melted minerals from the boiler floor to obtain a chemical conversion reaction from carbonates to sulfates. Such reactions produce mainly Potassium sulfate in economic and technically sustainable production rates. Moreover, this process neutralizes the harmful effects of the vinasse polluting residue.

### BACKGROUND OF THE INVENTION

1. Field of the Invention

The present invention relates to the field of processes, methods, industrial facilities and regulations used to remove harmful chemicals and/or convert them into harmless or less damaging chemicals. Particularly, the invention relates to a process for the treatment of vinasses obtained as a by-product of processes such as alcohol distillation and the like. Such process may render a useful chemical product such as potassium sulfate as well as electric power obtained from the combustion of such vinasse.

2. Description of Prior Art

To better understand the purpose and scope of the present invention, we shall describe the present status of the art with regard to vinasses as a by-product of the industry, especially of industries such as sugar refineries that produce ethyl alcohol obtained by the fermentation of sugar cane molasses. Furthermore, even though this invention refers mainly to vinasse as a by-product obtained from sugar cane fermentation, the process and facilities disclosed herein may be used with vinasses, sludge or equivalent mixtures from other sources and/or processes.

Vinasse is a liquid by-product from must distillation obtained during the sugar cane fermentation process to obtain ethanol. Vinasse originates from a variety of feedstocks such as sugar cane molasses, sugar beet molasses, corn, barley, etc. On one hand, vinasses have high organic content such as alcohol, organic acids, aldehydes; on the other hand they have a variety of minerals such as sulfur (S), phosphorous (P), nitrogen (N), magnesium (Mg), Calcium (Ca) and a high potassium (K) content. In general, vinasses show a pH that varies between 3 and 4. Likewise, its composition varies depending on its origin as well as on the state of the vinasse when supplied, for instance: molasses, juice or a mixture of them.

In general, the process to obtain alcohol from molasses sugars comprises a fermentation stage and a distillation stage where ethanol may be obtained and partitioned and the resulting residue is vinasse in the form of wet sludge. Such sludge generally has dry solids in approximately 11%. If such vinasse is submitted to no treatment and is directly poured into water sources, it consumes oxygen, kills fish and damages the ecosystem. Consequently, vinasse must be submitted to treatments that eliminate its negative effects for further use.

Nowadays, actions to neutralize the polluting effect of such vinasses and turn them useful are mostly aimed at achieving the following:
Reuse of vinasse during sugar cane plantation irrigation; however, in this case, total reuse of the obtained vinasse is not allowed since it may be drained in watercourses and pollute the water.
Concentration (%60) of dry solids in vinasse through evaporation to be commercialized as an organic-mineral fertilizer; however, this option presents limitations such as the potential market demand volume of such fertilizers and the power demanded during the evaporation of liquids.
Vinasse concentration through evaporation and it subsequent microbiological treatment in biodigesters with biogas production; however, this option is a partial solution since it leaves sludge residues with polluting effects in the digesters.

Apart from the previously mentioned options, there exist attempts to generate power through combustion of the previously added vinasse. Patent Application AR237911 suggested the neutralization of vinasse coming from ethyl alcohol and calcium hydroxide distillation by mixing it with the marrow from sugar cane bagasse; subsequently, the marrow and bagasse mixture is burnt in an industrial boiler until it is dried up to 50%. However, such option is still a problem to be solved due to the high investment levels required and the uncertain potential use of the ashes derived from combustion.

In view of the above, it shall be convenient a new process to guarantee that the investment and technical benefits from installing a vinasse processing plant shall be such that, at the same time, they may ensure the appropriate treatment of the vinasse residue and the economic and ecological sustainability of the applied process. For the purposes of the present invention, technical benefits shall be those that, from a physical point of view, allow the conversion of vinasse into power and/or novel useful substances. In particular, for the purposes of the present invention and as shall be described herein, the novel process of the present invention shall develop a profitable and ecological treatment of vinasse to obtain electric power and, at the same time, to produce potassium sulfate, a highly valued substance within the consumer market.

### BRIEF DESCRIPTION OF THE INVENTION

One of the purposes of the present invention is to provide a process designed to obtain potassium sulfate from vinasse and, in this way, ensure a good use to such vinasse. At the same time, such process shall contribute to avoid the pollutant filtration of such vinasse residue within the environment. Therefore, the purpose of this invention shall be to provide a process designed to obtain potassium sulfate from such vinasse in an environmentally sustainable way. At the same time, the process shall be carried out by means of safe and full performance equipment and facilities such as multistage evaporators, safe storage tanks, recovery boilers of the kind that work in combination with dissolution tanks and conversion reactors, among others, which may be provided by renowned manufacturers.

Consequently, the purpose of the present invention shall be to provide a process designed to obtain potassium sulfate from vinasse where such vinasse is mainly obtained as a by-product of ethyl alcohol (or similar) production distilleries with less than 60% of solid concentration of which approximately 11% are dry solids. The process consists in concentrating such vinasse through an evaporation process of at least one stage to obtain at least 60% of dry solids. Then the vinasse is burnt at least at 750° C. in a recovery boiler and the melted minerals resulting from such combustion are drained from the boiler floor to a dissolution tank where the minerals melted with water are dissolved at a temperature of at least 90°. Such dissolution is submitted to mechanical agitation and then sulfuric acid is added and the dissolution is made to react in a conversion reactor to obtain mainly chemical reactions such as conversion from potassium carbonate to Potassium sulfate among other minor reactions, for the purposes of the present invention.

Other additional purposes of the exemplary embodiments of the present invention shall be shown in the corresponding section “Detailed description of the invention” and in the annexed claims.

### BRIEF DESCRIPTION OF THE DRAWINGS

For better clarity and comprehension purposes, the present invention has been illustrated in several drawings, where the invention has been represented as a preferred embodiment, all of it by way of example, where:

FIG. 1 is a flow chart that represents the process to obtain potassium sulfate from vinasses according to the preferred embodiment of the present invention;

FIG. 2 is a diagram of a plant to carry out the process of the present invention according to such preferred embodiment.

### DETAILED DESCRIPTION OF THE INVENTION

To begin with, the description of an exemplary embodiment of the present invention and the corresponding annexed figures show that the disclosure of the present invention corresponds to a novel process to obtain potassium sulfate from vinasses. Although the process of the present invention will be described below through a preferred embodiment example, as a person skilled in the art may observe, the process is feasible in practice through equivalent embodiment deducted according to the benefits of what is here described and illustrated. As mentioned in the prior art, combustion is one of the options or actions that may make vinasse useful and neutralize its polluting effect. Combustion of vinasse, also known as vinasse burning, may produce energy that may be channeled to an industrial boiler to generate vapor and thus feed the energy generation turbines, or may produce heat energy that may be useful during other industrial processes such as firings, dryings, etc. This energetic use of vinasse may include vinasse non-flammable liquid evaporation processes that improve its energetic performance during combustion. However, such vinasse neutralization process and subsequent combustion according to current practice requires high investment levels and presents the matter as to the uncertain use of the ashes derived from combustion.

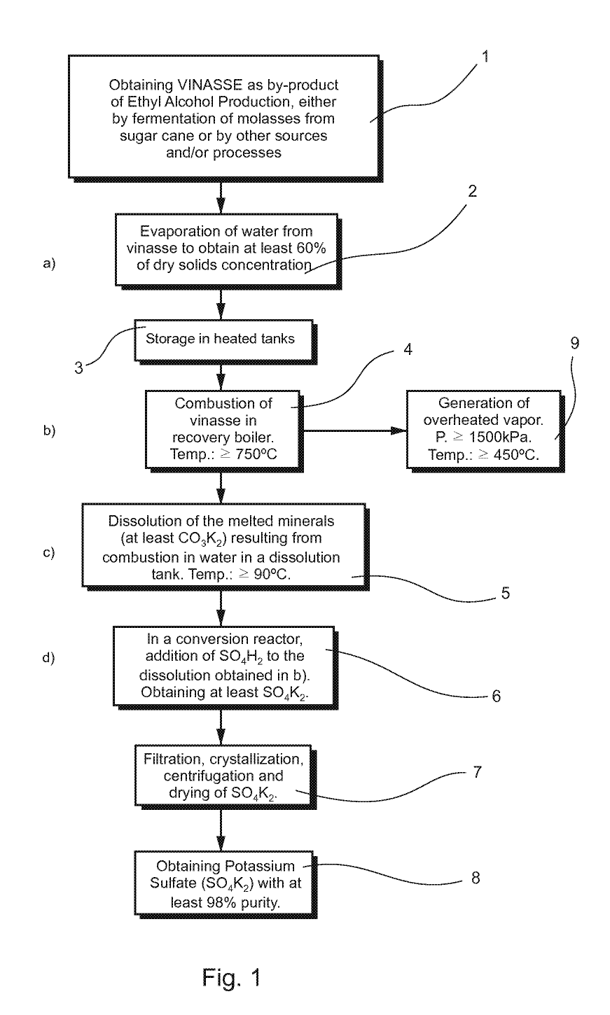

For that reason, by means of successive studies and tests aimed at solving the problem of vinasse burning or combustion with inventors of the present process have discovered a surprisingly novel and economically feasible way to industrially obtain potassium sulfate. These discoveries have revealed several steps and stages that define the process of FIG. 1, which may be implemented by means of technically available devices as described below.

Although such process may be fully expressed through a flow chart as illustrated in FIG. 1, it has been determined which stages are both novel and necessary and which are merely additional and/or commonly used.

Although the main purpose of the present invention is the productive use of vinasses, for the purposes of the present invention, vinasses constitute a feedstock or principal material to be processed during the industrial process described herein.

Vinasse from residue or by-product of other industrial processes, for instance, ethyl alcohol production processes in sugar refineries, constitute the starting point or main feedstock in FIG. 1, proposed as item (1).

### Use of Vinasse as Main Process Input

In the example, for the purposes of the present invention, Item (1) of flow chart, FIG. 1 corresponds to the obtaining of vinasse as by-product of ethyl alcohol production, either by fermentation of molasses from sugar cane or by other sources and/or processes. Although this starting point is common to other options related to the use of vinasse described in the prior art, it is clear that it constitute only a definition of the origin and nature of the main input used in this process, for the purposes of the present invention.

### Concentration of Dry Solids in Vinasse

Item (2) consists in concentrating vinasse through an evaporation process of at least one stage to obtain at least 60% of dry solids concentration. A high dry solids concentration improves the conditions and performance of the subsequent vinasse combustion.

To with, low dry solid concentration (i.e., high vinasse humidity) determines minor combustion energetic performance. On the contrary, high dry solid concentration improves the combustion energetic performance but determines a continuous increase in vinasse viscosity. For that reason, a minimum dry solids concentration of at least 11% is established. Preferably, dry solids concentration of at least 60% is established; and, more preferably, such dry solids concentration shall be near 70%.

Said dry solids concentration shall be carried out by means of an evaporation process of at least one stage. For such purposes, multiple-effect and multistage evaporators (14) with a capacity to achieve up to, for instance, 70% of dry solids concentration, shall preferably be used. This is in order to reach enough Heating Value to avoid the use of support fuel for burning.

It appears familiar that obtaining vinasse as by-product with 11% dry solid concentration facilitates its pumping through pipes since it is fluid enough to be pumped between storage tanks (11), for instance, from distilleries toward the production plant described herein. This process is very convenient since the consumption volume needed may be pumped through pipes (12) toward said evaporators before such vinasse is concentrated and more viscous.

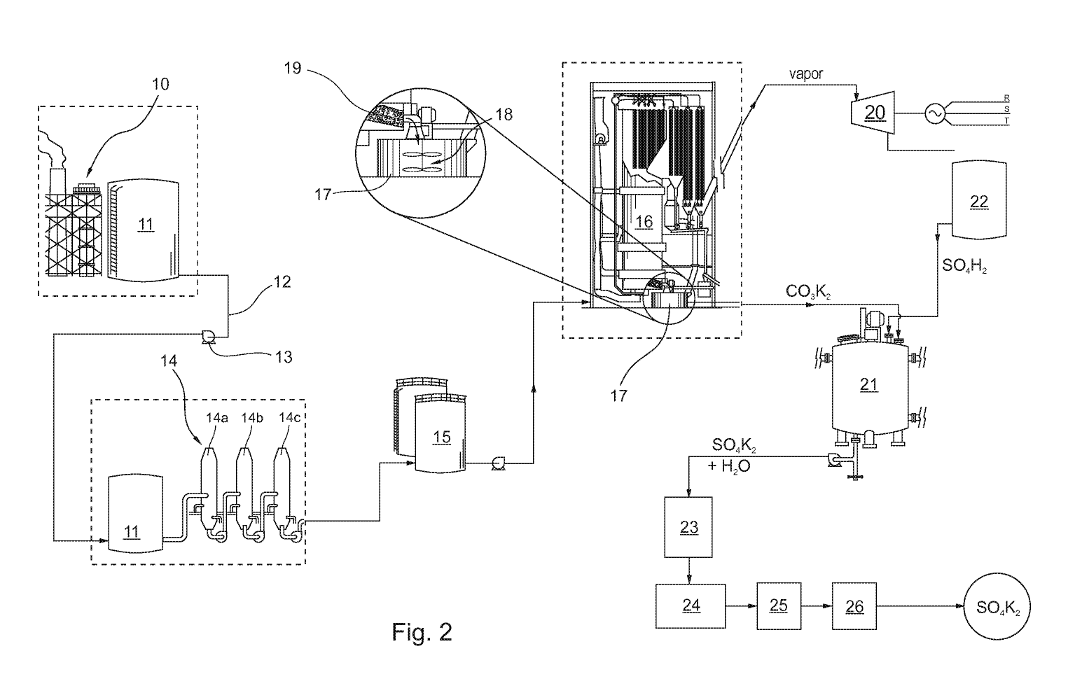

Multistage evaporators (14), schematically represented in FIG. 2 (for instance, with stages 14a, 14b, 14c, etc), are known in the art and their multiple stages allow the development of a cheaper process with respect to a single simple effect evaporator. The evaporation process is one of the key unit operations of chemical engineering and there exist many kinds of evaporators. However, most evaporators are designed with a heat exchanger. Therefore, most industrial evaporation systems generally consist of a heat exchanger to provide evaporation sensible and latent heat to the product to which the solid concentration shall be increased by liquid evaporation.

For the purposes of the present invention, preferably and by way of example, it is provided at least one multistage evaporator (14), with at least five stages, that shall produce vinasse with at least 70% of dry solids concentration and preferably, approximately at least 600 Tn/day.

Storage in Heated Tanks

At least 70% dry solid vinasse concentration establishes a viscosity increase and, therefore, diminishes its fluidity.

For such reason, and similarly to what happens with viscous materials that shall be stored and transferred through pipes and/or discharged through discharge outlets, in some occasions, it is convenient to raise or maintain the material temperature (in this case, that of the concentrated vinasse) to allow a better flow of vinasse in the processes. To such end, storage tanks (15) capable of heating its content (in this case, the vinasse) at an appropriate temperature to maintain the necessary fluidity level may be provided. As a preferred example, such tanks have a heating mechanism with heat exchangers designed to maintain the vinasse at a temperature of at least 50° C. More preferably, the temperature shall be maintained within 50° C. and 65° C. Nevertheless, this item (3) may also depend on the average temperature of the work environment and on the climatic region in question. In such sense, storage in heated tanks may not be necessary in all facilities of this kind.

### Combustion of Vinasse in Recovery Boiler

The next stage of the process of the present invention, item (4) of the flow chart, consists in burning such vinasse at a temperature of at least 750° C. in a recovery boiler (16) and draining the melted minerals (19) obtained from such vinasse combustion from the boiler floor (16) toward a dissolution tank (17).

This stage is essential for the purposes of the process of the present invention since it allows the immediate recovery of melted minerals (19) that descend to the specially sloping floor of said recovery boiler (16). Such melted minerals (19) are similar to volcanic lava and move through cooling channels toward said dissolution tank (17). This process is carried out continuously and boiler operators shall regularly check that the outlet of melted minerals is not obstructed. Minerals thus melted like this are very active. For such reason, in general, the dissolution tank (17) forms a part of the recovery boiler (16) and is operated according to the instructions of the manufacturer. Nevertheless, there may be more than one dissolution tank (17) and it may be separated from the recovery boiler (16) if necessary.

All of the organic compounds are burnt in the recovery boiler (16) and the minerals are reduced to their basic form. Then they oxidize and finally oxides turn into carbonates. In such sense, the main mineral components of ashes derived from combustion and those that are a part of the melted minerals (19) mentioned herein are: NaO₂ approximately 1.11%; KO₂ approximately 48.02%; CaO approximately 7.93%; MgO approximately 2.19%; Fe₂O₃ approximately 0.62% and Al₂O₃ approximately 0.044%. Furthermore, their reaction inside the recovery boiler (16) determines the combination of said oxides with carbon dioxide to obtain the corresponding carbonates, to with: CO₃Na₂, CO₃K₂, CO₃Ca, CO3Mg; (CO₃)3Fe₂; (CO₃)3Al₃. As shown hereunder, potassium carbonate CO₃K₂, precisely the most common mineral within such combustion ashes, presents the greatest interest for the purposes of the present invention.

Recovery boilers (16) are known within the art since they are mainly applied within the cellulose industry where the Kraft method is currently used during paper production. Notwithstanding the foregoing, the use of this kind of boilers in the present process is totally novel and differs completely from the aforementioned Kraft method. In short, the recovery boiler (16) generates vapor (9) from vinasse combustion; in other words, combustion of such vinasse in said recovery boiler (16) comprises the generation of economically and technically useful overheated vapor.

In order for such combustion to be effective, vinasse shall have a solid concentration of approximately 60%, as mentioned above, allowing a combustion at at least 750° C., and more preferably at least at 800° C. With respect to combustion capacity of vinasse solids, a daily vinasse consumption value may preferably be approximately 615 Tn/day of dry solids. Therefore, the boiler for such kind of work plan may be chosen, for instance, based on a boiler combustion capacity of 800 Tn/day of dry solids. To with, although such capacity is mentioned as being an economically self-sustaining capacity to carry out the process of the present invention, other kind of capacities, generally higher, may be used without this affecting or preventing the process of the present invention from being carried out correctly.

The output vapor of these recovery boilers (16) shall be sufficient to counter the power generation turbines backpressure (20). The preferred feeding value pressure for said turbines (20) is of at least 4500 KPa (45.89 Kg/cm²) and at an overheated vapor temperature of at least 450° C. To with, today, recovery boilers generate vapor at 8620 kPa (87.9 Kg/cm²) and at 490° C.

Some kinds of known recovery boilers may be provided by manufacturers such as METSO, Babcock & Wilcox Company, Mitsubishi Heavy Industries LTD and Andritz AG, among others.

### Dissolution of Melted Minerals in Water

Minerals melted due to gravity action are guided to the recovery boiler floor (16) and may be channeled toward a dissolution tank (17) to be dissolved in water at a temperature of at least 90°. In said dissolution tank (17), which is maintained at such temperature, minerals are submitted to continuous mechanical agitation. As mentioned above, the recovery boiler in general (16) includes a dissolution tank (17) with an intense agitation medium (18) with at least 2 sets of revolving blades, among other options. The salts solution resulting from the vinasse burning process is obtained in such dissolution tank (17), i.e., the aforementioned carbonates and, especially, the relevant potassium carbonate. The dissolution conditions of such minerals with water shall be carefully controlled and shall keep a continuous intense agitation since minerals eager to react in this stage of the process. In this respect, such dissolution tank includes a vapor vent system since vapors inevitably occur when melted minerals make contact with the liquid located inside the tank. Preferably, the water proportion with respect to melted minerals (19) is in the range of 10% to 20% as measured in terms of water weight in respect of melted minerals weight (19).

Obtaining the Reaction of Carbonates Dissolved in Water with Sulfuric Acid Inside a Conversion Reactor.

The dissolution of said melted minerals (19) may be reacted in a controlled manner in water with sulfuric acid inside a conversion reactor (21). Conversion reactors (21) are widely known within the chemical industry and may be acquired, assembled and operated safely according to the manufacturers' specifications to obtain mainly chemical reactions such as:

CO₃Na₃+SO₄H₂═SO₄Na₂+H₂O+CO₂;

CO₃K2+SO4H₂═SO₄K₂+H₂O+CO₂;

CO₃Ca+SO₄H₂═SO4Ca+H₂O+CO₂;

CO₃Mg+SO₄H₂═SO4Mg+H₂O+CO₂;

(CO₃)3Fe₂+3SO₄H₂═(SO₄)3Fe₂+3H₂O+3CO₂; and (CO₃)3Al₂+3SO₄H₂═(SO₄)3Al₂+3H₂O+3CO₂

Most conversion reactions are conversions from “carbonates” to “sulfates”. Carbonates belong to the carbonates group comprising sodium carbonate, magnesium carbonate, iron carbonate, calcium carbonate, aluminum carbonate and the conversion reaction respectively results in sodium sulfate, magnesium sulfate, iron sulfate, calcium sulfate and aluminum sulfate.

The proportion of sulfuric acid to be used in this stage may be established preferably in the range of 7% to 12% of sulfuric acid in respect of said dissolution of melted minerals with water. As a person skilled in the art may observe, such value may be adjusted in accordance with the characteristics of vinasse and the combustion product (melted minerals) obtained in the recovery boiler, among other considerations such as the amount of water added to the dissolution.

As described above, considering that there is a higher proportion of Potassium than the rest of the elements, a technically and economically amount of profitable Potassium sulfate SO₄K₂ may be obtained. This process of obtaining Potassium sulfate is attractive since it adds commercial value to the electric power generation of the turbine. We shall emphasize that potassium sulfate is in great demand by fertilizers industries and manufacturers. For reference, it shall be noted that Potassium sulfate to be used in fertilizer production is commercialized with a purity of 98.5% or more. In view of such consideration, Potassium sulfate obtained through the process of the present invention may be subsequently submitted to purification, slag removal and purging processes to reach the required purity of the final crystallized Potassium Sulfate, for instance, 99% or more. For the purposes of the present invention there are several processes designed to obtain approximately 99% purity. They are: filtration stages and steps that are preferably carried out through a mesh 30 or more, in a filtration equipment (23); crystallization stages or steps in which the potassium sulfate solution is concentrated at a supersaturated condition to obtain crystals after cooling the solution in a crystallization equipment (24); centrifugation stages or steps to be preferably carried out in a vertical axis centrifuge (25) with rotation speed of approximately 1200 to 2000 rpm; and finally, stages or steps to dry potassium sulfate crystals through exposure of such crystals to hot air in a dryer (26). In general, such kind of dryers and their working conditions may vary depending on the kind of drying process and the equipment design itself. Therefore, the working conditions of such drying process may perfectly be determined by a person skilled in the art.

As a person skilled in the art may observe, once the subsequent potassium sulfate is obtained pursuant to the process of the present invention, it may be purified and/or modified for use or commercialization without this constituting a condition or deviation from the spirit of the main protection purpose described in the annexed claims.

We claim:

1. A process to obtain potassium sulfate from vinasse, in which such vinasse is mainly a by-product of ethyl alcohol and the like production distilleries with less than 60% of solid concentration of which approximately 11% are dry solids, wherein the process comprises the following steps:
a) concentrate such vinasse through an evaporation process of at least one stage and obtain at least 60% of dry solids,
b) burn such vinasse at least at 750° C. in a recovery boiler and drain the melted minerals resulting from such combustion from the boiler floor to a dissolution tank,
c) dissolve the melted minerals with water in such dissolution tank at a temperature of at least 90′; submitting such melted minerals to mechanical agitation, and
d) add sulfuric acid to the dissolution of melted minerals and water in a conversion reactor to obtain mainly chemical reactions such as
CO3K2+SO4H2=SO4K2+CO2+H2O,
and to obtain, in this way, at least potassium sulfate.

2. The process to obtain potassium sulfate from vinasse according to claim 1, wherein the water proportion with respect to dissolved melted minerals is in the range of 10% to 20% as measured in terms of weight.

3. The process to obtain potassium sulfate from vinasse according to claim 1, wherein the proportion of sulfuric acid with respect to said dissolution of melted minerals with water is in the range of 7% to 12% as measured in terms of weight.

4. The process to obtain potassium sulfate from vinasse according to claim 1, wherein after such step d, the potassium sulfate therein obtained is filtered, crystallized, centrifuged and dried.

5. The process to obtain potassium sulfate from vinasse according to claim 1, wherein the combustion of such vinasse in said recovery boiler comprises the generation of overheated vapor.

6. The process to obtain potassium sulfate from vinasse according to claim 5, wherein such overheated vapor is fed to a power generation turbine, and where such overheated vapor has at least 1500 kPa pressure and a temperature of at least 450° C.

7. The process to obtain potassium sulfate from vinasse according to claim 1, wherein in addition to the main reactions described in step d, other conversion reactions from carbonates to sulfates are obtained. Carbonates belong to the carbonates group comprising sodium carbonate, magnesium carbonate, iron carbonate, calcium carbonate, aluminum carbonate and the conversion reaction respectively results in sodium sulfate, magnesium sulfate, iron sulfate, calcium sulfate and aluminum sulfate.

8. The process to obtain potassium sulfate from vinasse according to claim 1, wherein before the vinasse burning step b), the vinasse is stored in heated tanks at a temperature of at least 50° C.

9. The process to obtain potassium sulfate from vinasse according to claim 2, wherein said filtration is carried out through a mesh 30 or more, said crystallization is carried out by concentrating the potassium sulfate solution at a supersaturated condition to obtain crystals after the solution is cooled, said centrifugation is carried out in a vertical axis centrifuge and said drying is carried out through exposure of such crystals to hot air.
